(19) United States
(12) Patent Application Publication
(10) Pub. No.: US 2018/0366044 A1
(43) Pub. Date: Dec. 20, 2018

(54) HOUSING OF FIRE EMERGENCY INDICATING LIGHT

(71) Applicant: LOSE INTERNATIONAL ELECTRIC CO.,LTD, Jiangmen City (CN)

(72) Inventor: GuiSheng ZHONG, Jiangmen city (CN)

(21) Appl. No.: 15/915,362

(22) Filed: Mar. 8, 2018

(30) Foreign Application Priority Data
Jun. 15, 2017 (CN) 201710453937.8

(51) Int. Cl. G09F 13/04; F21V 25/12; F21V 7/04

(52) U.S. Cl. CPC G09F 13/0413; F21V 25/12; G09F 2013/0459; G09F 2013/0445; F21V 7/04

(57) ABSTRACT

A housing of a fire emergency indicating light, wherein the housing is molded from fireproof plastics through one processing and comprises a rectangle-shaped frame, a reflective plate configured in the frame, and a refractive plate configured in the frame. The production process is simple, the molding time is short, the recycling is easy, and the housing is insulating with no occurrence of electric leakage accidents, moreover, the housing is not easy to deform, thereby more effectively protecting lights; through the design of a reflective plate and a refractive plate, the light rays are more uniform, and the utilization rate of light is higher; when the housing is used in the assembly of a light, the process is simple, and the steps are extremely few, thereby greatly improving production efficiency and lowering product cost, meanwhile, the appearance is more fine and elegant, thereby satisfying more life requirements of people and creating good economic benefits for enterprises.

### TECHNICAL FIELD

The present invention relates to the field of emergency lighting equipment, and in particular to a housing of a fire emergency indicating light.

### BACKGROUND ART

According to the requirements of fire safety, public buildings need to be installed with fire emergency indicating lights used for fire emergency evacuation indications. The housing of a traditional fire emergency indicating light is assembled by numerous metal parts and plastic plugs. The metal parts are high in cost and long in molding time, and need to be subjected to a series of procedures including cutting, stamping and spraying; moreover, the metal parts are difficult to be recycled, thereby leading to a waste of resources and pollution to the environment. For the indicating light assembled by metal parts, in order to prevent electric leakage accidents, a large amount of insulating paper needs to be wrapped on the circuit board; for the purpose of grounding, the back plate of the indicating light needs to be broken down, and the appearance of a light is destroyed, therefore, even though a large number of protection measures have been taken, electric leakage accidents still occur.

Since the parts are numerous in quantity, complex in processing and tedious in assembling steps, the molding time of a product is overlong, moreover, as the metal is easy to deform, then during production and transportation, the rejection rate is high and the cost of products rises; due to the limitations of such factors as the characteristics and processing technologies of metal, it is difficult for the designers to further improve the structure of the fire emergency indicating light; after a product is molded, electric leakage accidents easily occur, so the product has the shortcomings of unsafety, difficulty in recycling, and environmental pollution.

### SUMMARY OF THE INVENTION

In order to solve the above problem, the present invention provides a housing of a fire emergency indicating light, wherein the housing is molded from fireproof plastics through one processing and includes a rectangle-shaped frame, a reflective plate configured in the frame, and a refractive plate configured in the frame.

The frame can be divided into an upper frame, a lower frame, a left frame and a right frame, wherein the lower frame is provided with a through hole and a control button, the reflective plate is connected with the upper frame and the lower frame in a vertical manner, and divides the housing into a left irradiated area, a middle irradiated area and a right irradiated area, a gap is formed between the reflective plate and the lower frame to form a plate clamping position, and the refractive plate is arranged in the three irradiated areas.

Another solution is as follows: the back face of the frame is further provided with an inclined plate which inclines inwards from the outside, the angle between the inclined plate and the frame should be slightly smaller than 90 degrees, the inclined plate is provided with an outlet hole, numerous wire clamping positions and an 86 box installation position, the upper frame, the left frame and the right frame are all provided with side holes, and the inclined plate is further provided with a hanging hole vertical to the frame.

Through the above structure, the housing of fire emergency indicating light in the present invention can be divided into a single-sided housing and a double-sided housing. The two types of housings are both molded from fireproof plastics through one processing, the production process is simple, the molding time is short, the recycling is easy, and the housing is insulating with no occurrence of electric leakage accidents, moreover, the housing is not easy to deform, thereby more effectively protecting lights; through the design of a reflective plate and a refractive plate, the light rays are more uniform, and the utilization rate of light is higher; when the housing is used in the assembly of a light, the process is simple, and the steps are extremely few, thereby greatly improving production efficiency and lowering product cost, meanwhile, the appearance is more fine and elegant, thereby satisfying more life requirements of people and creating good economic benefits for enterprises.

### BRIEF DESCRIPTION OF THE DRAWINGS

FIG. 1 is a perspective view of embodiment 1.

FIG. 2 is a perspective view of embodiment 1 after assembly.

FIG. 3 is perspective front view of embodiment 2 after a circuit board is assembled.

FIG. 4 is a perspective back view of embodiment 2 after assembly.

FIG. 5 is a sectional view of A-A in FIG. 3.

### DETAILED DESCRIPTION OF THE EMBODIMENTS

Specific embodiments of the present invention will be described in detail below with reference to the accompanying drawings.

### Embodiment 1

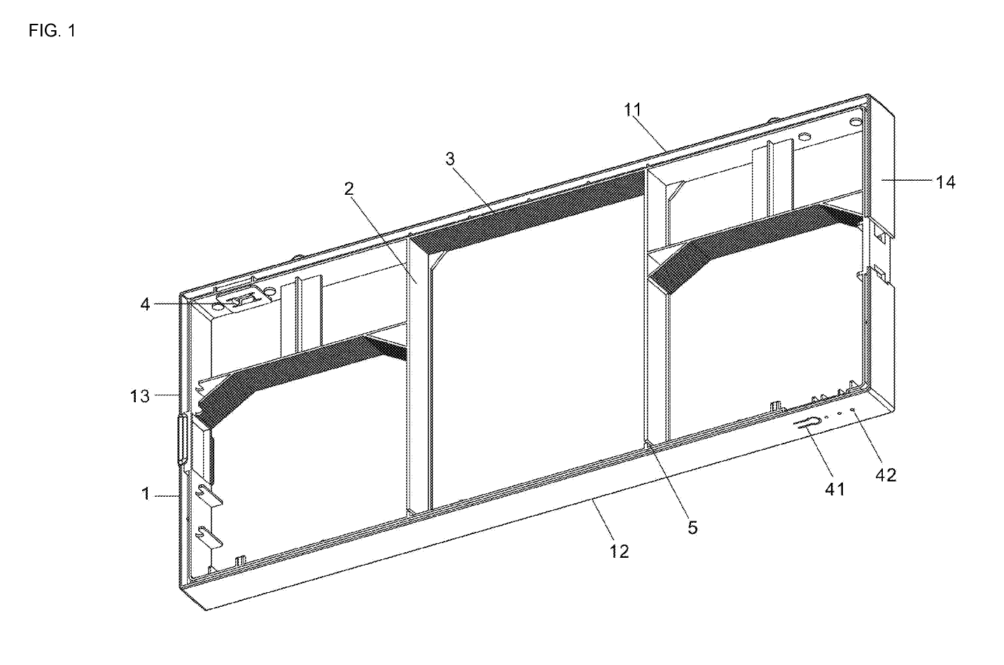

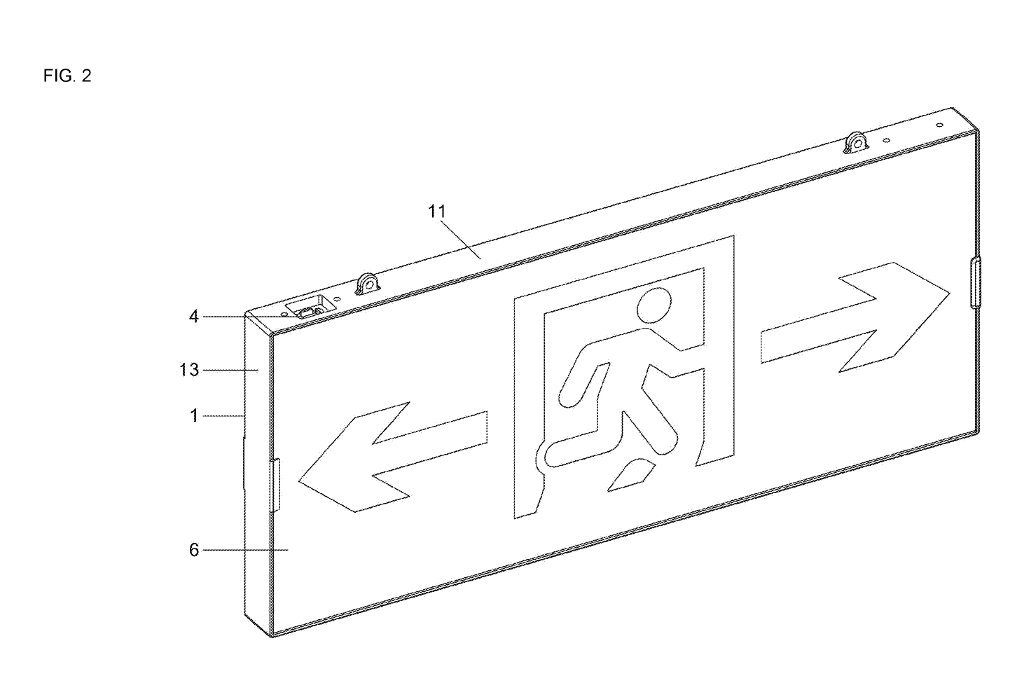

As shown in FIG. 1 and FIG. 2, the present invention provides a housing of a fire emergency indicating light, wherein the housing is molded from fireproof plastics through one processing and includes a rectangle-shaped frame 1, a reflective plate 2 configured in the frame 1, and a refractive plate 3 configured in the frame 1. The frame 1 can be divided into an upper frame 11, a lower frame 12, a left frame 13 and a right frame 14, wherein the upper frame 11 is provided with an outlet hole 4, the lower frame 12 is provided with a through hole 41 and a control button 42, the reflective plate 2 is connected with the upper frame 11 and the lower frame 12 in a vertical manner, and divides the housing into a left irradiated area, a middle irradiated area and a right irradiated area, a gap is formed between the reflective plate 2 and the lower frame 12 to form a plate clamping position 5, and the refractive plate 3 is arranged in the three irradiated areas.

When a circuit board is installed at the plate clamping position 5, a power line penetrates out via the outlet hole 4, and two pieces of indicating panels 6 are installed at the front face and back face of the housing, then a novel double-sided fire emergency indicating light is formed.

### Embodiment 2

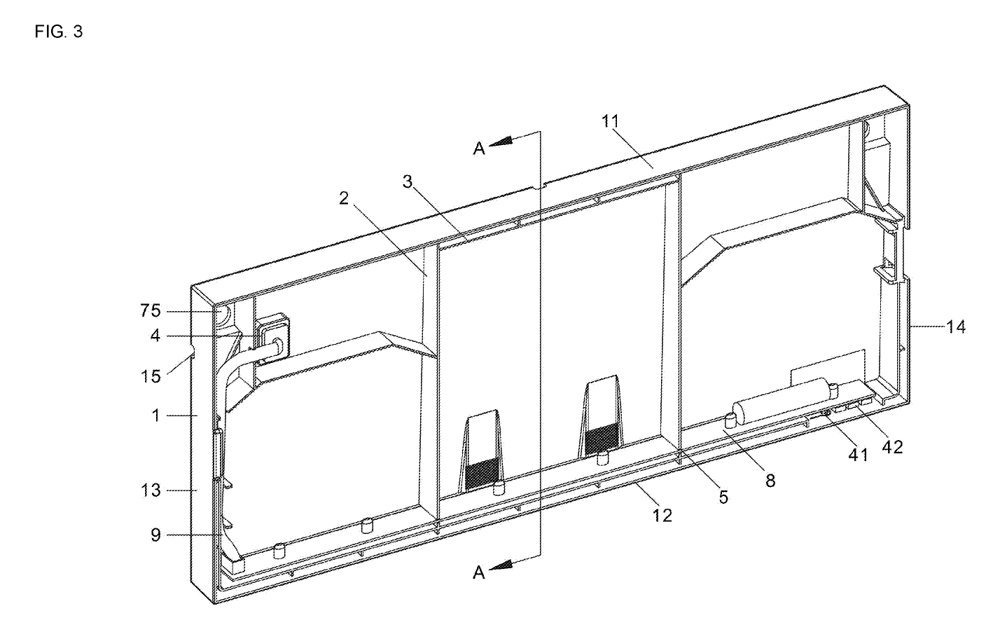

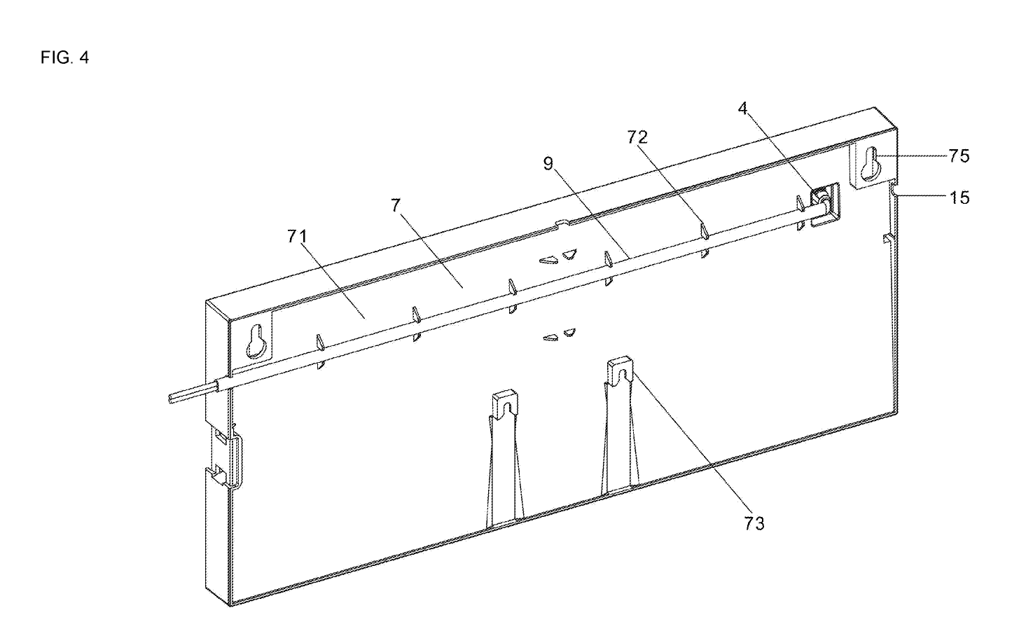

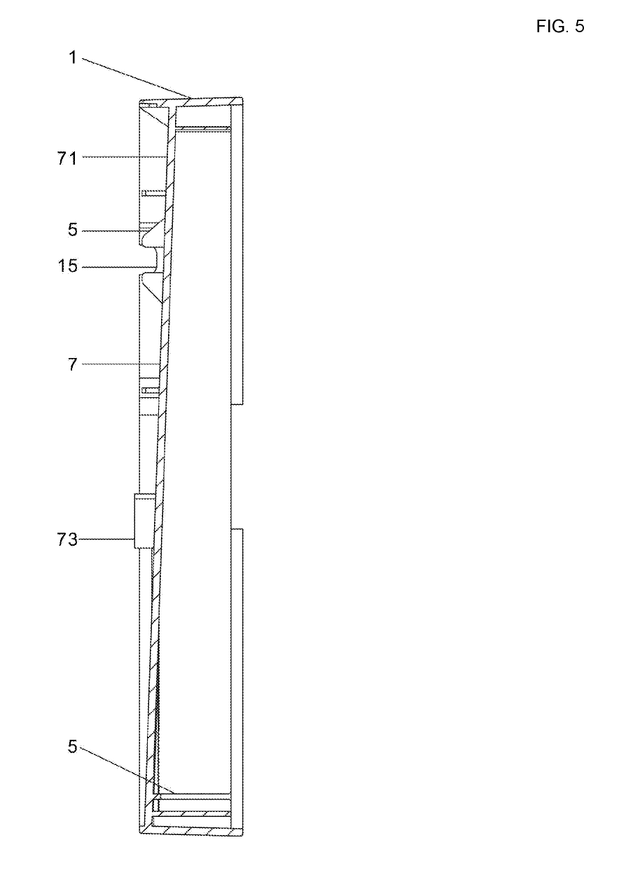

As shown in FIG. 3, FIG. 4 and FIG. 5, the present invention provides a housing of a fire emergency indicating light, wherein the housing is molded from fireproof plastics through one processing and includes a rectangle-shaped frame 1, a reflective plate 2 configured in the frame 1, and a refractive plate 3 configured in the frame 1. The frame 1 can be divided into an upper frame 11, a lower frame 12, a left frame 13 and a right frame 14, wherein the lower frame 12 is provided with a through hole 41 and a control button 42, the reflective plate 2 is connected with the upper frame 11 and the lower frame 12 in a vertical manner, and divides the housing into a left irradiated area, a middle irradiated area and a right irradiated area, a gap is formed between the reflective plate 2 and the lower frame 12 to form a plate clamping position 5, and the refractive plate 3 is arranged in the three irradiated areas; the back face of the frame 1 is further provided with an inclined plate 7 which inclines inwards from the outside, the angle between the inclined plate 7 and the frame 1 should be slightly smaller than 90 degrees, and due to its inclination, the inclined plate 7 forms a groove 71 with the frame 1, the inclined plate 7 is provided with an outlet hole 4, numerous wire clamping positions 72 and an 86 box installation position 73, the upper frame 11, the left frame 13 and the right frame 14 are all provided with side holes 15, and the inclined plate 7 is further provided with a hanging hole 75 vertical to the frame 1.

When a circuit board 8 is installed at the plate clamping position 5, and a power line 9 penetrates out via the outlet hole 4, a novel single-sided fire emergency indicating light can be formed. The groove 71 is in cooperation with the wire clamping position 72 to effectively protect the power line, and based on the positions of the wire clamping position 72 and the side hole 15, users can select the wire outlet modes in different directions, thereby increasing the diversification of products.

The housing of fire emergency indicating light provided by the present invention is molded from fireproof plastics through one processing, the production process is simple, the molding time is short, the recycling is easy, and the housing is insulating with no occurrence of electric leakage accidents, moreover, the housing is not easy to deform, thereby more effectively protecting lights; through the design of a reflective plate 2, a refractive plate 3, and an inclined plate 7, the light rays are more uniform, and the utilization rate of light is higher; when the housing is used in the assembly of a light, the process is simple, and the steps are extremely few, thereby greatly improving production efficiency and lowering product cost, meanwhile, the appearance is more fine and elegant, thereby satisfying more life requirements of people and creating good economic benefits for enterprises.

The embodiments of the present invention are described in detail above in combination with the accompanying drawings, however, the present invention is not limited to the above embodiments. Within the mastered knowledge range, those skilled in the art can make various modifications to the present invention without departing from the purpose of the present invention, and these modifications shall all fall within the protection scope of the present invention.

1. A housing of a fire emergency indicating light, wherein the housing is molded from fireproof plastics through one processing and comprises a rectangle-shaped frame, a reflective plate configured in the frame, and a refractive plate configured in the frame.

2. The housing of a fire emergency indicating light of claim 1, wherein the frame can be divided into an upper frame, a lower frame, a left frame and a right frame, the lower frame is provided with a through hole and a control button, the reflective plate is connected with the upper frame and the lower frame in a vertical manner, and divides the housing into a left irradiated area, a middle irradiated area and a right irradiated area, a gap is formed between the reflective plate and the lower frame to form a plate clamping position, and the refractive plate is arranged in the three irradiated areas.

3. The housing of a fire emergency indicating light of claim 1, wherein the back face of the frame is further provided with an inclined plate which inclines inwards from the outside, the angle between the inclined plate and the frame should be slightly smaller than 90 degrees, the inclined plate is provided with an outlet hole, numerous wire clamping positions and an 86 box installation position, the upper frame, the left frame and the right frame are all provided with side holes, and the inclined plate is further provided with a hanging hole vertical to the frame.
